(19) United States
(12) Patent Application Publication
(10) Pub. No.: US 2006/0014518 A1
(43) Pub. Date: Jan. 19, 2006

(54) Mobile phone payment method and system

(75) Inventors: Moon-haeng Huh, Seoul (KR); Dong-kook Kim, Seoul (KR); Eui-seob Shin, Seoul (KR); Choong-ki Kim, Seoul (KR)

Correspondence Address: DILWORTH & BARRESE, LLP, 333 EARLE OVINGTON BLVD., UNIONDALE, NY, 11553, US

(73) Assignees: KBC INC., SEOUL (KR); SMARTINT, SEOUL (KR)

(21) Appl. No.: 10/893,836

(22) Filed: Jul. 19, 2004

(51) Int. Cl. H04Q 7/20; H04M 11/00

(52) U.S. Cl. 455/406; 455/408; 455/550.1

(57) ABSTRACT

A mobile phone payment method and system in which a mobile phone, a photo receiver, and a control server for storing payment-related information of a user of the mobile phone, download the payment-related information of the user from the control server to the mobile phone. The payment-related information is converted into binary code data. A light signal from a backlight of the mobile phone, based on the binary code data, is transmitted to the photo receiver. The photo receiver authenticates the binary data from the received light signal and authorizes payment accordingly.

### BACKGROUND OF THE INVENTION

1. Field of the Invention

The present invention relates to a mobile phone payment method and system.

2. Description of the Related Art

In general, the most common means for paying for goods and services is with paper money or a check. However, at certain times, it may be inconvenient or even dangerous to carry paper money or a check. In order to solve this problem, credit cards and debit cards are commonly used, such that the paper money or a check does not have to be carried. However, there is also a problem in that, when the credit card is lost or stolen, the owner may suffer a great deal of damages from unauthorized use of the credit card.

In recent years, a mobile phone payment system has been developed in order to solve the problem of the credit card. The mobile phone payment system is mainly used for small-valued payments. Further, in the conventional mobile phone system, a signal transmitting device or a wireless Internet connection device is separately provided to the mobile phone. Therefore, there is a problem in that production costs of the mobile phone increase. In addition, there is another problem in that the mobile phone is complex and large.

### SUMMARY OF THE INVENTION

In order to solve the above and other problems, an object of the present invention is to provide a mobile phone payment system, which is implemented by updating software, without additional hardware modules.

Another object of the present invention is to provide a mobile phone payment method by which a user of a mobile phone can make a payment by using the mobile phone.

According to an aspect of the present invention, there is provided a mobile phone payment system using a light signal having payment-related information. The mobile phone payment system includes: a mobile phone; a photo receiver; and a control server. The photo receiver includes: a photo sensor for receiving the light signal from a mobile phone, and converting the light signal into an electrical signal; a data error determination unit for receiving the electrical signal of the photo sensor, and determining an error of the electrical signal; a control unit for transmitting the electrical signal of the photo sensor to the data error determination unit, outputting a control signal based on the result of the error determination by the data error determination unit, and outputting the electrical signal if the electrical signal has no error; a display unit for displaying presence or absence of the error of the light signal in response to the control signal; an encryption unit for encrypting the electrical signal transmitted from the control unit; and a first communication unit for transmitting the encrypted signal to the control server. The control server includes: a data storage unit for storing personal information of a subscribed user; a decoder for decoding the encrypted signal transmitted from the photo receiver; a comparator for comparing information decoded by the decoder with the associated information stored in the data storage unit; a payment authentication unit for authenticating the payment requested by the user if the information decoded by the decoder is identical to the associated information stored in the data storage unit; and a second communication unit for transmitting the result of the payment authentication to the mobile phone.

According to another aspect of the present invention, there is provided a mobile phone payment method for use in a system including a mobile phone, a photo receiver, and a control server for storing payment-related information of a user of the mobile phone. The method includes steps of: downloading the payment-related information of the user from the control server to the mobile phone and storing the payment-related information in the mobile phone; converting the payment-related information into a binary code data in response to the user's request; generating a light signal having a series of pulses by turning on and off a backlight of the mobile phone based on the binary code data and transmitting the light signal to the photo receiver; receiving the light signal in the photo receiver, converting the received light signal into an electrical signal and transmitting the electrical signal from the photo receiver to the control server; receiving the electrical signal, comparing payment-related information contained in the electrical signal with the payment-related information of the user stored in the control server and determining if the transmitted payment-related information is correct; if the transmitted payment-related information is correct, authenticating the user's payment; and transmitting the result of the determining step from the control server to at least one of the mobile phone and the photo receiver.

According to still another aspect of the present invention, there is provided a photo receiver for receiving a light signal from a mobile phone, converting the light signal to an electrical signal, and transmitting the electrical signal to a control server. The photo receiver includes: a photo sensor for receiving a light signal from a mobile phone, and converting the light signal into an electrical signal; a data error determination unit for receiving the electrical signal of the photo sensor and determining an error of the electrical signal; a control unit for transmitting the electrical signal of the photo sensor to the data error determination unit, outputting a control signal based on the result of the error determination by data error determination unit, and outputting the electrical signal if the electrical signal has no error; a display unit for displaying an error status of the light signal in response to the control signal; and a communication unit for transmitting the electrical signal from the control unit to the control server.

According to further still another aspect of the present invention, there is provided a control server for use in a mobile phone payment system including a mobile phone for outputting a predetermined light signal, a photo receiver for converting the received light signal to an electrical signal, encrypting the electrical signal, and outputting the encrypted electrical signal as an output signal, and the control server for authenticating payment by using the output signal of the photo receiver. The control server includes: a data storage unit for storing personal information of a subscribed user; a decoder for decoding the signal transmitted from the photo receiver; a comparator for comparing information decoded by the decoder with the associated information stored in the data storage unit; a payment authentication unit for authenticating the payment if the information decoded by the decoder is identical to the associated information stored in the data storage unit; and a communication unit for transmitting the result of the payment authentication to the mobile phone.

According to further still another aspect of the present invention, there is provided a mobile phone payment method using a mobile phone. The method includes the steps of: accessing a server to download payment-related information of a subscribed user from the server to the mobile phone; converting the payment-related information to a binary code data in the mobile phone; generating a light signal having a series of pulses by turning on and off a backlight of the mobile phone based on the binary code data; and transmitting the light signal from the mobile phone to an control sever.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram illustrating a mobile phone payment system according to an embodiment of the present invention;

FIG. 2 is a waveform diagram illustrating pulses of a light signal generated by a backlight of a mobile phone used for the mobile phone payment system illustrated in FIG. 1;

FIG. 3 is a block diagram illustrating a photo receiver as illustrated in FIG. 1;

FIG. 4 is a block diagram illustrating a control server as illustrated in FIG. 1 in detail; and

FIG. 5 is a flowchart illustrating a mobile phone payment method according to an embodiment of the present invention.

### DETAILED DESCRIPTION OF THE INVENTION

The present invention and operational advantages thereof can be fully understood by referring to the accompanying drawings and explanations thereof.

Herein below, exemplary embodiments of the present invention will be described with reference to the accompanying drawings to explain the present invention in more detail. In the drawings, the same reference numerals indicate the same elements.

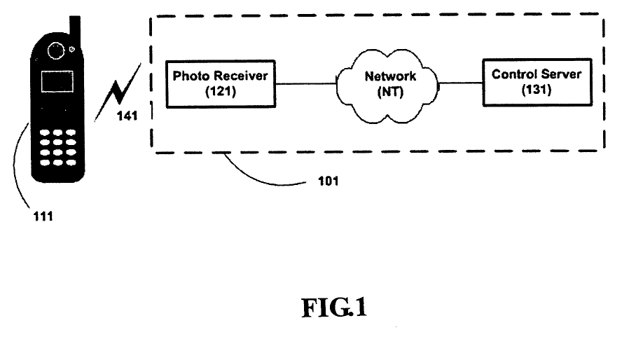

FIG. 1 is a block diagram illustrating a mobile phone payment system according to an embodiment of the present invention. The mobile phone payment system includes a mobile phone 111, a photo receiver 121, and a control server 131. The mobile phone 111 has a display unit such as an LCD (Liquid Crystal Display), an EL (Electroluminescent), and an organic EL illuminated with a backlight. Some types of the mobile phone 111 may have a keypad illuminated with a keypad-dedicated backlight such as a blue LED (Light Emitting Diode). In the mobile phone payment system according to the present invention, a light signal is generated in a form of pulses by turning on and off the backlight of the mobile phone based on payment-related information. More specifically, the light signal includes the payment-related information. Therefore, the user of the mobile phone can make payments by using his or her mobile phone.

In order to use the mobile phone payment system 101, a user accesses the control server 131 to subscribe to the mobile phone payment service by transmitting personal information to the control server 131. The personal information includes, for example, identification (ID) information, a credit card number, an E-mail address, E-money information, and a phone number of the user. The control server 131 stores the personal information in a data storage unit. The user downloads a program used for the mobile phone payment service from the control server 131 and installs the program in the mobile phone 111.

As a result, the user can pay a charge by using the mobile phone 111. The charge may include, for example, a charge for a video game machine or a roller coaster, a charge for a gambling machine, an admission fee of a theater, a toll, a public vehicle fare, a parking fee, etc. In addition, the mobile phone 111 may be used to pay for gasoline or a vending-machine item. Further, the mobile phone 111 may also be used to transfer E-money in an ATM (Automatic Teller Machine).

Preferably, the mobile phone 111 includes a button or buttons for activating the program. Alternatively, the mobile phone 111 may set a button of the keypad to activate the program.

When the user pushes the button on the mobile phone 111, payment-related information of the user is downloaded from the control server 131 to the mobile phone 111. Alternatively, the payment-related information may be previously downloaded from the control server 131 and stored in a memory of the mobile phone, to be used if necessary. Herein, the payment-related information represents information used to make payments, which is transmitted from the mobile phone 111 to the photo receiver 121. The payment-related information includes identification (ID) information, a credit card number, and associated passwords or PIN numbers of the user.

The payment-related information is converted in binary code data. The mobile phone 111 generates a light signal 141 having a series of pulses by turning on and off a backlight of the mobile phone 111 based on the binary code data. Accordingly, the mobile phone 111 transmits the light signal 141 to the photo receiver 121.

Alternatively, before converted into the binary code data, the payment-related information may be encrypted in order to secure the payment-related information. The light signal is generated based on the encrypted binary code data and transmitted to the photo receiver 121.

The photo receiver 121 preferably includes a photo sensor and a data error determination unit. The photo sensor of the photo receiver 121 receives the light signal 141 and converts the light signal into an electrical signal. The received light signal includes the payment-related information. The data error determination unit determines whether the light signal is transmitted without error from the mobile phone 111 to the photo receiver 121. If the light signal is determined to be transmitted without error form the mobile phone 111 to the photo receiver 121, the photo receiver 121 transmits the electrical signal from the photo sensor through a network NT to the control server 131. If, however, the light signal is not determined to be transmitted without error form the mobile phone 111 to the photo receiver 121, the photo receiver 121 displays a message (an error status message) indicating that there is an error in the transmitted payment-related information, such that the user may transmit the light signal corresponding the payment-related information again.

The control server 131 compares the transmitted payment-related information with the associated information stored in the control server 131. If the transmitted payment-related information is identical to the associated information stored in the control server 131, the control server 131 authenticates the user's payment by using the payment-related information, which includes credit card information or E-money information of the user, as described above.

The control server 131 sends a short text message indicating the result of payment to the user's mobile phone 111 through Short Message Service server. If the transmitted payment-related information is not identical to the associated information stored in the control server 131, the control server 131 sends to the user's mobile phone 111 through Short Message Service server a short text message indicating that the transmitted payment-related information is incorrect. In addition, the control sever 131 transmits the result of the payment to the photo receiver 121 in order to inform a manager of the photo receiver of the result of the payment. If the payment is not authenticated, the user may transmit the payment-related information again to perform the aforementioned payment process.

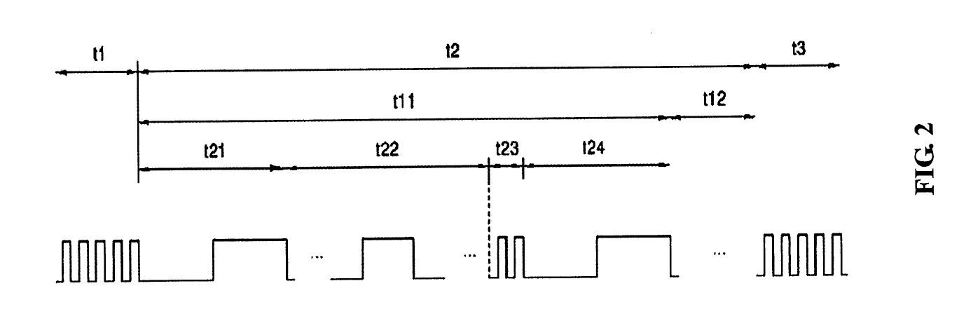

FIG. 2 is a waveform diagram showing pulses of a light signal 141 generated by a backlight of a mobile phone 111 used for a mobile phone payment system of FIG. 1. The light signal 141 is partitioned into a starting frame t1, an information frame t2, and an ending frame t3. The starting frame t1 includes a plurality of short pulses to indicate the starting point of the light signal 141, the information frame t2 includes a plurality of pulses generated based on the payment-related information, and the ending frame t3 includes a plurality of pulses to indicate the ending point of the light signal 141.

The information frame t2 is constructed with a plurality of information bits t11 and t12. In addition, the information bit t11 is partitioned into a starting bit t21, a main bit t22, a parity bit t23, and a stop bit t24. The starting bit t21 indicates the starting point of the information bit t11, the main bit t22 represents real information with “1” or “0” bit, and the parity bit t23 is used to determine whether or not the light signal 141 is transmitted without error. The stop bit t24 indicates the ending point of the information bit t11.

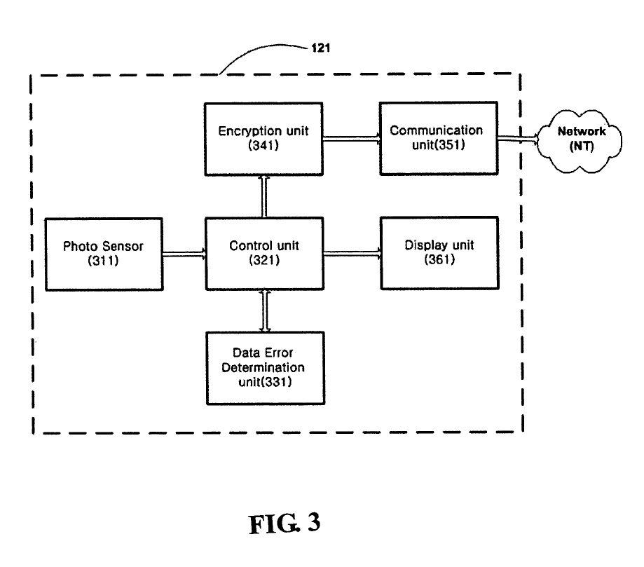

FIG. 3 is a block diagram illustrating the photo receiver 121 as illustrated in FIG. 1. The photo receiver 121 includes a photo sensor 311, a data error determination unit 331, a control unit 321, a display unit 361, an encryption unit 341, and a communication unit 351. The photo sensor 311 detects a light signal 141 transmitted from the mobile phone 111, converts the light signal 141 to an electrical signal, and transmits the electrical signal as an output signal to the control unit 321.

The data error determination unit 331 receives the output signal of the photo sensor 311 via the control unit 321, determines if the light signal 141 is transmitted from the photo sensor 311 without error, and transmits a result of the determination to the control unit 321.

The control unit 321 transmits the output signal of the photo sensor 311 to the data determination unit 331, and transmits a control signal to the display unit 361 in response to the result of the determination of the data error determination unit 331. If the light signal 141 is determined to be transmitted without error, the control unit 321 transmits the output signal of the photo sensor 311 to the encryption unit 341.

The display unit 361 displays an error status of the light signal 141 in response to the control signal of the control unit 321. The display unit 361 includes a plurality of lighting devices (not shown) such as LED (light emitting device) and lamps. For example, if the light signal 141 has an error, a first lighting device is turned on; if not, a second lighting device is turned on. If a signal indicating that the payment-related information transmitted from the mobile phone 111 is correct is transmitted from the control server 131, a third lighting device is turned on; if not, a fourth lighting device is turned on.

The encryption unit 341 encrypts the output signal of the photo sensor 311 transmitted from the control unit 321. The encrypting method used by the encryption unit 341 includes, for example, a method of increasing or decreasing the number of pulses of the light signal 141, and a method of increasing or decreasing widths of the pulses in comparison to a width of a basic pulse of the light signal.

The communication unit 351 transmits an output signal of the encryption unit 341 to the control server 131 via a network NT. The network NT may be constructed with a wire network such as the Internet, a local area network (LAN), a public switched telephone network (PSTN), an integrated services digital network (ISDN), or a wireless network.

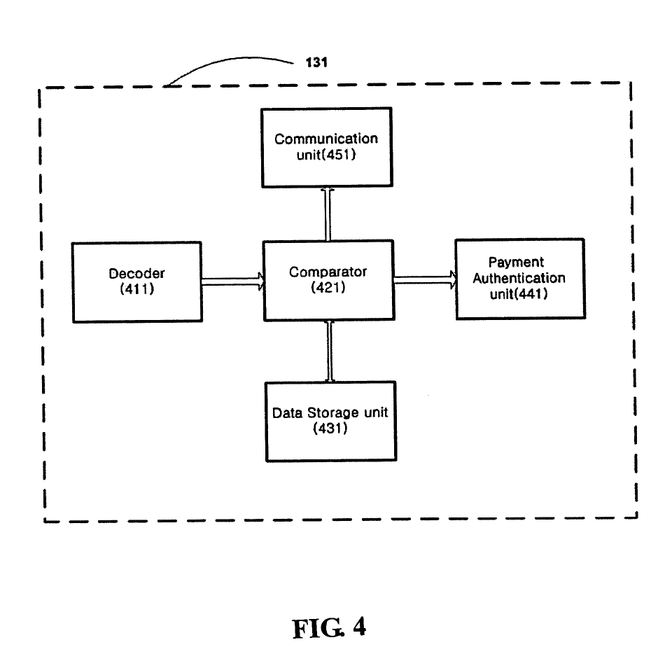

FIG. 4 is a block diagram illustrating the control server 131 as illustrated in FIG. 1, in detail. The control server includes a data storage unit 431, a decoder 411, a data comparator 421, a payment authentication unit 441, and a communication unit 451. The data storage unit 431 stores personal information of a subscribed user, the decoder 411 decodes the signal transmitted from the photo receiver 121, the data comparator 421 compares information decoded by the decoder 411 with the associated information stored in the data storage unit 431, and the payment authentication unit 441 authenticates the payment requested by the user, if the information decoded by the decoder is identical to the associated information stored in the data storage unit. The communication unit 451 transmits a result of the payment authentication to the mobile phone 111.

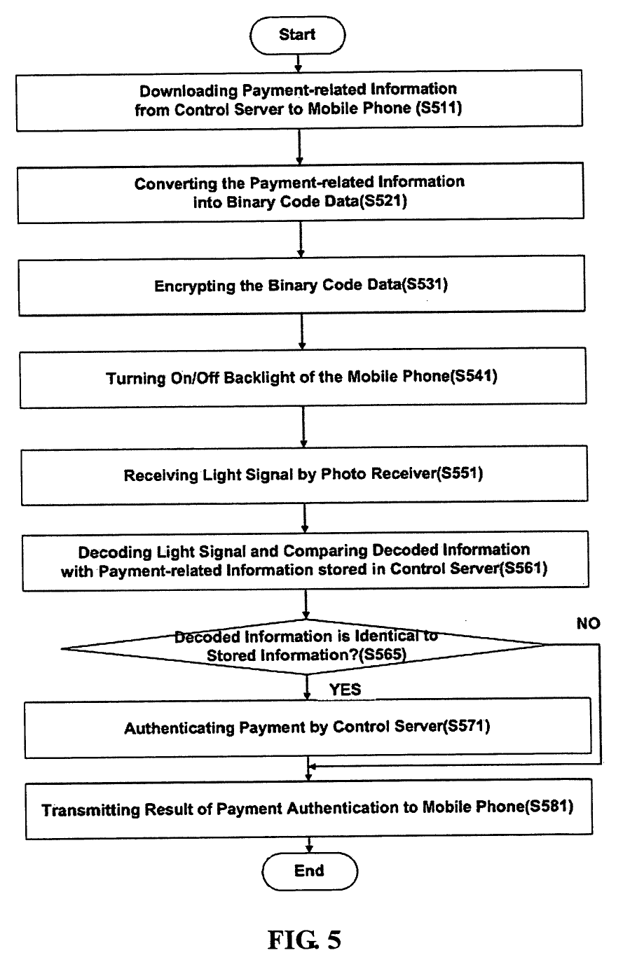

FIG. 5 is a flowchart illustrating a mobile phone payment method according to an embodiment of the present invention. Referring to FIG. 5, in a first step S511, the mobile phone 111 downloads payment-related information of a user from a control server 131. The payment-related information is stored in the mobile phone. The payment-related information includes at least one of identification (ID) information and a credit card number, and the associated passwords of the user.

In step S521, the mobile phone 111 converts the payment-related information into a binary code data in response to a user's request. Accordingly, the binary code data is constructed with a plurality of “1” and “0” bits.

In step S531, the mobile phone 111 encrypts the binary code data. By the encrypting, for example, the number of pulses of a light signal can increase or decrease, or the widths of the pulses of the light can increase or decrease in comparison to the width of a basic pulse of the light signal, as illustrated in FIG. 2.

In step S541, the mobile phone 111 generates the light signal having a series of pulses and transmits the light signal to the photo receiver 121. Preferably, the light signal is generated by turning on and off a backlight of the mobile phone 111 based on the binary code data. When the backlight is turned on and off, the levels of the encrypted pulses are “0” and “1”, respectively. Therefore, the light signal has a series of encrypted pluses having predetermined time intervals.

In step S551, the photo receiver 121 receives and converts the light signal into an electrical signal and transmits the electrical signal as an output signal of the photo receiver 121 to the control server 131. The photo receiver 121 performs the operations described above with reference to FIG. 3.

In step S561, the control server 561 decodes the output signal of the photo receiver 121, compares the decoded payment-related information with the payment-related information of the user stored in a database of the control server 131, and determines if the decoded payment-related information is correct in Step S565.

In step S571, if the decoded payment-related information is identical to the payment-related information stored in the control server 131, the control server 131 authenticates the user's payment. However, in step S581, the control server 131 transmits the result of the determination of step S561 to the mobile phone and the photo receiver. If the decoded payment-related information, that is, the payment-related information transmitted from the mobile phone 111, is identical to the payment-related information stored in the control server 131, the control server 131 authenticates the user's payment and transmits the result of the payment to the mobile phone 111 and the photo receiver 121. However, if the decoded payment-related information is not identical to the payment-related information stored in the control server 131, the control server 131 transmits the message that the user's payment is not authenticated to the mobile phone 111 and the photo receiver 121, such that the user may transmit the payment-related information again.

According to the present invention, it is possible for a user of a mobile phone to make payments by using the mobile phone, without carrying paper money or a credit card.

In addition, it is possible to make payments by using a mobile phone payment system being implemented by updating software of the mobile phone without additional hardware modules. Therefore, it is possible to reduce production costs of mobile phones.

While the present invention has been particularly shown and described with reference to exemplary embodiments thereof and specific terms such as a mobile phone 111, a photo receiver 121, and a control server 131, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A mobile phone payment system using a light signal including payment-related information, comprising:
a mobile phone;
a photo receiver; and
a control server,
wherein the mobile phone comprises:
a memory for storing the payment-related information of a user; and
a first control unit for controlling a backlight of the mobile phone to transmit the light signal to the photo receiver,
wherein the photo receiver comprises:
a photo sensor for receiving the light signal from the mobile phone, and converting the light signal into an electrical signal;
a data error determination unit for receiving the electrical signal of the photo sensor, and determining an error of the electrical signal;
a second control unit for transmitting the electrical signal of the photo sensor to the data error determination unit, outputting a control signal based on a result of the error determination by the data error determination unit, and outputting the electrical signal if the electrical signal has no error;
a display unit for displaying an error status of the light signal in response to the control signal;
an encryption unit for encrypting the electrical signal transmitted from the control unit; and
a first communication unit for transmitting the encrypted signal to the control server, and
wherein the control server comprises:
a data storage unit for storing personal information of a subscribed user;
a decoder for decoding the encrypted signal transmitted from the photo receiver;
a comparator for comparing information decoded by the decoder with the personal information stored in the data storage unit;
a payment authentication unit for authenticating the payment requested by the user if the information decoded by the decoder is identical to the personal information stored in the data storage unit; and
a second communication unit for transmitting a result of the payment authentication to the mobile phone.

2. The mobile phone payment system according to claim 1, wherein the photo receiver transmits a signal to the control server in one of a wired and wireless manner, and the control server transmits a signal to the mobile phone in a wireless manner.

3. The mobile phone payment system according to claim 1, wherein the payment-related information includes at least one of identification (ID) information, a credit card number, and associated passwords of the user.

4. A mobile phone payment method used for a system including a mobile phone, a photo receiver, and a control server for storing payment-related information of a user of the mobile phone, the method comprising steps of:
downloading the payment-related information of the user from the control server to the mobile phone;
storing the payment-related information in the mobile phone;
converting the payment-related information into binary code data;
generating a light signal having a series of pulses from a backlight of the mobile phone based on the binary code data;
transmitting the light signal to the photo receiver;
receiving the light signal in the photo receiver;
converting the received light signal into an electrical signal;
transmitting the electrical signal from the photo receiver to the control server;
receiving the electrical signal;
comparing payment-related information contained in the electrical signal with the payment-related information of the user stored in the control server to determine if the transmitted payment-related information is correct;
if the transmitted payment-related information is correct, authenticating the user's payment; and
transmitting the result of the comparing step from the control server to at least one of the mobile phone and the photo receiver.

5. The mobile phone payment method according to claim 4, further comprising the steps of:
encrypting the binary code data; and
decoding the received encrypted electrical signal.

6. The mobile phone payment method according to claim 4, wherein the payment-related information includes at least one of identification (ID) information, a credit card number, and associated passwords of the user.

7. A photo receiver for use in a mobile phone payment system, the photo receiver comprising:
a photo sensor for receiving a light signal from a mobile phone, and converting the light signal into an electrical signal;
a data error determination unit for receiving the electrical signal of the photo sensor and determining an error of the electrical signal;
a control unit for transmitting the electrical signal of the photo sensor to the data error determination unit, outputting a control signal based on a result of the error determination by data error determination unit, and outputting the electrical signal if the electrical signal has no error;
a display unit for displaying an error status of the light signal in response to the control signal; and
a communication unit for transmitting the electrical signal from the control unit to a control server.

8. The photo receiver according to claim 7, further comprising:
an encryption unit for encrypting the electrical signal transmitted from the control unit, and
a communication unit for transmitting the encrypted signal by the encryption unit to the control server.

9. The photo receiver according to claim 7, wherein the display unit comprises at least one of a first lighting device which is turned on, if the light signal has an error, and a second lighting device which is turned on, if the light signal has no error.

10. The photo receiver according to claim 7, wherein the display unit comprises at least one of a third lighting device, which is turned on, if a signal indicating that the payment-related information transmitted from the mobile phone is correct is transmitted from the control server, and a fourth lighting device is turned on, if a signal indicating that the payment-related information transmitted from the mobile phone is incorrect is transmitted from the control server.

11. The photo receiver according to claim 10, wherein the control unit receives a predetermined signal from the control server via the communication unit and controls the operation of the display unit in accordance with the received signal.

12. A control server for use in a mobile phone payment system including a mobile phone for outputting a predetermined light signal, a photo receiver for converting the received light signal to an electrical signal, encrypting the electrical signal, and outputting the encrypted electrical signal as an output signal, and the control server for authenticating payment by using the output signal of the photo receiver, the control server comprising:
a data storage unit for storing personal information of a subscribed user;
a decoder for decoding the signal transmitted from the photo receiver;
a comparator for comparing information decoded by the decoder with the personal information stored in the data storage unit;
a payment authentication unit for authenticating a payment if the information decoded by the decoder is identical to the personal information stored in the data storage unit; and
a communication unit for transmitting a result of the payment authentication to the mobile phone.

13. A mobile phone payment method using a mobile phone, comprising steps of:
accessing a server to download payment-related information of a subscribed user from the server to the mobile phone;
converting the payment-related information into binary code data in the mobile phone;
generating a light signal having a series of pulses from a backlight of the mobile phone based on the binary code data; and
transmitting the light signal from the mobile phone to an control sever.

14. The mobile phone payment method of claim 13, further comprising a step of encrypting the binary code data.

15. The mobile phone payment method of claim 13, wherein the payment-related information includes at least one of identification (ID) information, a credit card number, and associated passwords of the user.

16. A mobile phone payment system using a light signal including payment-related information, comprising:
a mobile phone including a memory for storing the payment-related information of a user, and a first control unit for controlling a backlight of the mobile phone to transmit the light signal;
a photo receiver including a photo sensor for receiving the light signal from the mobile phone, and converting the light signal into an electrical signal, a data error determination unit for receiving the electrical signal of the photo sensor and determining an error of the electrical signal, a second control unit for transmitting the electrical signal of the photo sensor to the data error determination unit, outputting a control signal based on a result of the error determination by the data error determination unit, and outputting the electrical signal if the electrical signal has no error, a display unit for displaying an error status of the light signal in response to the control signal, an encryption unit for encrypting the electrical signal transmitted from the control unit, and a first communication unit for transmitting the encrypted signal; and
a control server including a data storage unit for storing personal information of a subscribed user, a decoder for decoding the encrypted signal transmitted from the photo receiver, a comparator for comparing information decoded by the decoder with the personal information stored in the data storage unit, a payment authentication unit for authenticating the payment requested by the user if the information decoded by the decoder is identical to the personal information stored in the data storage unit, and a second communication unit for transmitting a result of the payment authentication to the mobile phone.
